(19) United States
(12) Patent Application Publication
(10) Pub. No.: US 2023/0369654 A1
(43) Pub. Date: Nov. 16, 2023

(54) ALL-SOLID-STATE BATTERY HAVING HIGH CAPACITY AND EXCELLENT DURABILITY AND METHOD FOR MANUFACTURING THE SAME

(71) Applicants: HYUNDAI MOTOR COMPANY, Seoul (KR); KIA CORPORATION, Seoul (KR)

(72) Inventors: Sung Man Cho, Gwacheon-si (KR); Young Jin Nam, Suwon-si (KR); Hong Suk Choi, Hwaseong-si (KR); Seon Hwa Kim, Cheongju-si (KR); Hee Soo Kang, Seoul (KR); Jae Min Lim, Suwon-si (KR); Sang Wan Kim, Anyang-si (KR)

(73) Assignees: Hyundai Motor Company, Seoul (KR); Kia Corporation, Seoul (KR)

(21) Appl. No.: 17/994,964

(22) Filed: Nov. 28, 2022

(30) Foreign Application Priority Data
May 13, 2022 (KR) 10-2022-0058920

(51) Int. Cl. H01M 10/0585; H01M 10/0562

(52) U.S. Cl. CPC H01M 10/0585; H01M 10/0562; H01M 2300/0068

(57) ABSTRACT

Disclosed are an all-solid-state battery having high capacity and excellent durability and a method for manufacturing the same. The method includes preparing a first solid electrolyte part including a first transfer film layer and a first layer disposed on the first transfer film layer and including a first solid electrolyte, preparing a second solid electrolyte part including a second transfer film layer and a second layer disposed on the second transfer film layer and including a second solid electrolyte, forming a first solid electrolyte layer on a cathode part by transferring the first layer onto the cathode part, forming a second solid electrolyte layer on an anode part by transferring the second layer onto the anode part, and preparing a stack by stacking the first solid electrolyte layer and the second solid electrolyte layer so as to come into contact with each other.

### CROSS-REFERENCE TO RELATED APPLICATION

This application claims under 35 U.S.C. § 119(a) the benefit of priority to Korean Patent Application No. 10-2022-0058920 filed on May 13, 2022 in the Korean Intellectual Property Office, the entire contents of which are incorporated herein by reference.

### TECHNICAL FIELD

The present disclosure relates to an all-solid-state battery having high capacity and excellent durability and a method for manufacturing the same.

### BACKGROUND

An all-solid-battery includes a cathode layer, an anode layer, and a solid electrolyte layer interposed between the cathode layer and the anode layer.

The solid electrolyte layer may be manufactured by applying a slurry including a solid electrolyte directly to the cathode layer or the anode layer. However, resistance of a cell may be increased due to side reactions between the slurry and an electrode. Further, when the slurry is applied to the anode layer, the slurry is dried in the state in which the slurry permeates into pores of the anode layer, and thus, lithium ions may precipitate within the anode layer. This causes deterioration of the capacity, efficiency and output characteristics of the cell.

The solid electrolyte layer may be formed as a self-standing film, and may be provided between the cathode layer and the anode layer. However, the solid electrolyte layer has low mechanical properties, such as strength, stiffness, flexibility, etc., and thus needs to have a thickness equal to or greater than 100 μm. Such a thickness of the solid electrolyte layer reduces energy density of the all-solid-state battery. When the content of a binder in the solid electrolyte layer is increased to reduce the thickness of the solid electrolyte layer, lithium ion conductivity may be reduced.

In order to solve such a problem, a solid electrolyte layer including a porous non-woven fabric has been developed. However, it is difficult to impregnate all pores of the porous non-woven fabric with a solid electrolyte, and it is not easy to reduce the thickness of the solid electrolyte layer due to the thickness of the porous non-woven fabric.

Further, a method for transferring a solid electrolyte layer onto one electrode layer may be considered. The solid electrolyte layer may be thinly coated on a transfer film, and may be transferred onto the electrode layer by a method using a roll press, a flat press or the like. When such a transfer process is applied, it is easy to form a thin solid electrolyte layer. Further, the solid electrolyte layer is densely formed through a process of applying heat and pressure.

However, when compressibility is excessively high during the transfer process, the surface of the solid electrolyte layer is hardened, and thus, the interface between the solid electrolyte layer and the other electrode layer adhered to the surface of the solid electrolyte layer may not be uniformly formed. This causes increase in interfacial resistance, and hinders conduction of lithium ions, thereby being capable of reducing the capacity and output of an all-solid-state battery.

On the other hand, when compressibility is low during the transfer process, interfacial contact between the solid electrolyte layer and the electrode layer is not properly performed, and thus, voids may be incurred. Consequently, non-uniform lithium deposition may occur when the all-solid-state battery is charged, and may thus reduce coulombic efficiency and durability.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an object of the present disclosure to provide an all-solid-state battery which may minimize interfacial resistance of a transferred solid electrolyte layer, and a method for manufacturing the same.

In one aspect, the present disclosure provides a method for manufacturing an all-solid-state battery, the method including preparing a first solid electrolyte part including a first transfer film layer and a first layer disposed on the first transfer film layer and including a first solid electrolyte, preparing a second solid electrolyte part including a second transfer film layer and a second layer disposed on the second transfer film layer and including a second solid electrolyte, forming a first solid electrolyte layer on a cathode part by transferring the first layer onto the cathode part, forming a second solid electrolyte layer on an anode part by transferring the second layer onto the anode part, and preparing a stack by stacking the first solid electrolyte layer and the second solid electrolyte layer so as to come into contact with each other.

In a preferred embodiment, the first transfer film layer may include at least one selected from the group consisting of polyethylene naphthalate (PEN), fluorinated polyimide (FPI) and a combination thereof.

In another preferred embodiment, in the preparing the first solid electrolyte part, the first layer may be formed by applying a slurry to the first transfer film layer, and the slurry may include at least a sulfide-based solid electrolyte and a binder.

In still another preferred embodiment, the second transfer film layer may include at least one selected from the group consisting of polyethylene naphthalate (PEN), fluorinated polyimide (FPI) and a combination thereof.

In yet another preferred embodiment, in the preparing the second solid electrolyte part, the second layer may be formed by applying a slurry to the second transfer film layer, and the slurry may include at least a sulfide-based solid electrolyte and a binder.

In still yet another preferred embodiment, in the forming the first solid electrolyte layer, the first layer may be transferred onto the cathode part by stacking the first solid electrolyte part on the cathode part such that the first layer comes into contact with the cathode part and then applying a pressure of about 130 MPa to 140 MPa at a temperature of about 120° C. to 130° C.

In a further preferred embodiment, a thickness of the first solid electrolyte layer may be about 15 μm to 25 μm.

In another further preferred embodiment, the first layer and the first solid electrolyte layer may satisfy Equation 1 below,

$$15 \leq \frac{{V}_{1 , 0} - {V}_{1}}{{V}_{1 , 0}} \times 100 \leq 20 , \qquad [ Equation 1 ]$$

and

In Equation 1, V_{1,0} may indicate a volume of the first layer, and V₁ may indicate a volume of the first solid electrolyte layer.

In still another further preferred embodiment, a thickness of the second solid electrolyte layer may be about 30 μm to 40 μm.

In yet another further preferred embodiment, in the forming the second solid electrolyte layer, the second layer may be transferred onto the anode part by stacking the second solid electrolyte part on the anode part such that the second layer comes into contact with the anode part and then applying a pressure of about 140 MPa to 150 MPa at a temperature of about 100° C. to 110° C.

In still yet another further preferred embodiment, the second layer and the second solid electrolyte layer may satisfy Equation 2 below,

$$20 \leq \frac{{V}_{2 , 0} - {V}_{2}}{{V}_{2 , 0}} \times 100 \leq 25 , \qquad [ Equation 2 ]$$

and

In Equation 2, V_{2,0} may indicate a volume of the second layer, and V₂ may indicate a volume of the second solid electrolyte layer.

In a still further preferred embodiment, the method may further include isostatically pressing the stack at a pressure of about 400 MPa to 500 MPa and a temperature of about 60° C. to 100° C.

In another aspect, the present disclosure provides an all-solid-state battery including an anode part, a second solid electrolyte layer disposed on the anode part, a first solid electrolyte layer disposed on the second solid electrolyte layer, and a cathode part disposed on the first solid electrolyte layer, wherein the first solid electrolyte layer and the second electrolyte layer have different thicknesses.

In a preferred embodiment, the thickness of the second solid electrolyte layer may be greater than the thickness of the first solid electrolyte layer.

In another preferred embodiment, the thickness of the first solid electrolyte layer may be about 15 μm to 25 μm.

In still another preferred embodiment, the thickness of the second solid electrolyte layer may be about 30 μm to 40 μm.

In yet another preferred embodiment, a ratio (a/b) of the thickness (a) of the first solid electrolyte layer to the thickness (b) of the second solid electrolyte layer may be about 0.37 to 0.83.

In still yet another preferred embodiment, a density of the first solid electrolyte layer may be about 1.20 mg/mm³ to 1.40 mg/mm³.

In a further preferred embodiment, a density of the second solid electrolyte layer may be about 1.40 mg/mm³ to 1.60 mg/mm³.

In another further preferred embodiment, the second solid electrolyte layer may include a central part and an edge part other than the central part based on a plane of the second solid electrolyte layer, and the first solid electrolyte layer may be disposed on the central part.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a cross-sectional view of an all-solid-state battery according to the present disclosure;

FIGS. 2A to 2G are reference views illustrating a method for manufacturing the all-solid-state battery according to the present disclosure;

FIG. 3A shows an initial discharge capacity of an all-solid-state battery according to Example;

FIG. 3B shows lifespan characteristics of the all-solid-state battery according to Example;

FIG. 4A shows an initial discharge capacity of an all-solid-state battery according to Comparative Example 1;

FIG. 4B shows lifespan characteristics of the all-solid-state battery according to Comparative Example 1;

FIG. 5A shows an initial discharge capacity of an all-solid-state battery according to Comparative Example 2;

FIG. 5B shows lifespan characteristics of the all-solid-state battery according to Comparative Example 2;

FIG. 6A shows an initial discharge capacity of an all-solid-state battery according to Comparative Example 3; and

FIG. 6B shows lifespan characteristics of the all-solid-state battery according to Comparative Example 3.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given herein below with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. As used herein, the term “about” means modifying, for example, lengths, degrees of errors, dimensions, the quantity of an ingredient in a composition, concentrations, volumes, process temperature, process time, yields, flow rates, pressures, and like values, and ranges thereof, refers to variation in the numerical quantity that may occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. Whether modified by the term “about” the claims appended hereto include equivalents to these quantities. The term “about” further may refer to a range of values that are similar to the stated reference value. In certain embodiments, the term “about” refers to a range of values that fall within 10, 9, 8,7, 6, 5,4, 3, 2, 1 percent above or below the numerical value (except where such number would exceed 100% of a possible value or go below 0%) or a plus/minus manufacturing/measurement tolerance of the numerical value. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

FIG. 1 shows a cross-sectional view of an all-solid-state battery according to the present disclosure. The all-solid-state battery may include a cathode part 10, an anode part 20, a first solid electrolyte layer 30 located adjacent to the cathode part 10 between the cathode part 10 and the anode part 20, and a second solid electrolyte layer 40 located adjacent to the anode part 20 between the cathode part 10 and the anode part 20.

In the conventional transfer method, a solid electrolyte layer is transferred onto one electrode, and the other electrode is stacked on the solid electrolyte layer. During a process of transferring the solid electrolyte layer, the surface of the solid electrolyte layer may be hardened, and thus, interface contact at the interface between the solid electrolyte layer and the other electrode may be poor. When the solid electrolyte layer is transferred, a transfer product may warp due to a difference between volume expansion coefficients of the electrode and the solid electrolyte layer.

On the other hand, in the present disclosure, the first solid electrolyte layer 30 and the second solid electrolyte layer 40 are formed on the cathode part 10 and the anode part 20 by a transfer method, respectively, and then, the first solid electrolyte layer 30 and the second solid electrolyte layer 40 are bonded to each other. The first solid electrolyte layer 30 and the second solid electrolyte layer 40 include the same kind of materials or similar materials, and thus, the interface therebetween is uniformly formed when they are bonded after transfer. Consequently, according to the present disclosure, interfacial resistance in the all-solid-state battery is reduced, as compared to the conventional transfer method using a single solid electrolyte layer, and thus, the charge/discharge capacity and durability of the all-solid-state battery are greatly improved.

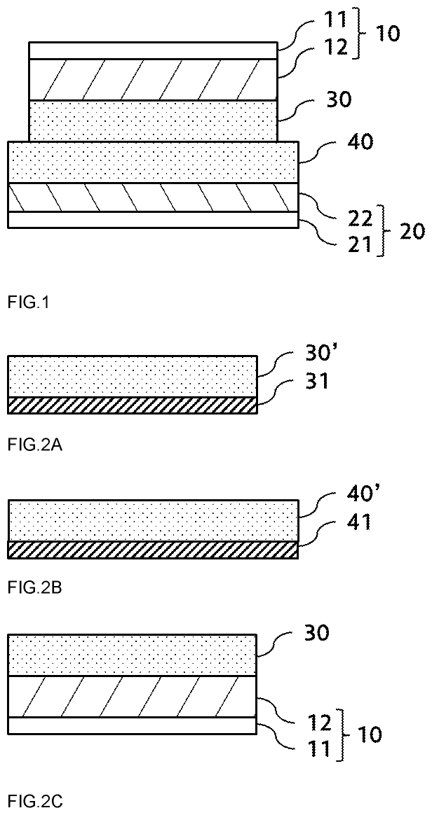

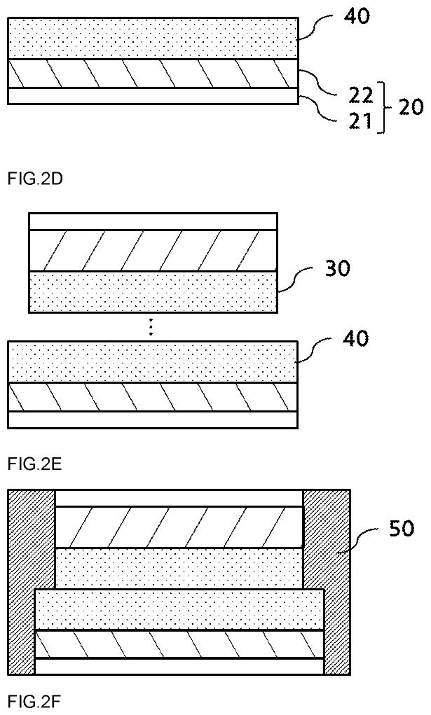

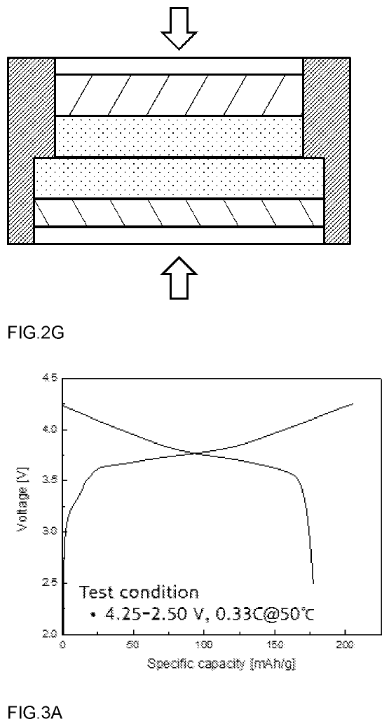

Hereinafter, referring to FIGS. 2A to 2G, a method for manufacturing the all-solid-state battery according to the present disclosure will be described in detail. The method may include preparing a first solid electrolyte part including a first transfer film layer 31 and a first layer 30′ disposed on the first transfer film layer 31 (S1), preparing a second solid electrolyte part including a second transfer film layer 41 and a second layer 40′ disposed on the second transfer film layer 41 (S2), forming the first solid electrolyte layer 30 by transferring the first layer 30′ onto the cathode part 10 (S3), forming the second solid electrolyte layer 40 by transferring the second layer 40′ onto the anode part 20 (S4), preparing a stack by stacking the first solid electrolyte layer 30 and the second solid electrolyte layer 40 so as to come into contact with each other (S5), adhering an insulating member 50 on the side surfaces of the stack (S6), and pressing the stack (S6).

Referring to FIG. 2A, the first solid electrolyte part may include the first transfer film layer 31 and the first layer 30′ disposed on the first transfer film layer 31.

The first transfer film layer 31 may include at least one selected from the group consisting of polyethylene naphthalate (PEN), fluorinated polyimide (FPI) and a combination thereof.

The first layer 30′ may be formed by applying a slurry including at least a first solid electrolyte and a binder to the first transfer film layer 31.

The first solid electrolyte may include a sulfide-based solid electrolyte. The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), or Li₁₀GeP₂S₁₂.

The binder may include a butadiene rubber (BR)-based binder, an acrylate-based binder, a fluorine-based binder or the like.

The slurry may further include a solvent, a dispersant, etc. The solvent may include any solvent which does not react with the sulfide-based solid electrolyte or has low reactivity with the sulfide-based solid electrolyte. For example, the solvent may include heptane, xylene, butyl butyrate, toluene, or the like.

The slurry may be manufactured by adding the sulfide-based solid electrolyte, the binder and the dispersant into the solvent and mixing all the components. For example, the slurry may be manufactured by mixing the sulfide-based solid electrolyte, the binder and the dispersant at a weight ratio of about 94-99:0.9-5:0.1-1.

The first layer 30′ may be formed by applying the slurry to the first transfer film layer 31 and then drying the slurry. Application of the slurry is not limited to a specific method, and may be achieved by methods using tape casting, a doctor blade, etc. After the slurry is applied, the slurry may be dried at a temperature of about 60° C. to 150° C. in a dry room, in a vacuum or in an inert gas atmosphere. Here, the dry room may indicate a space configured such that air therein maintains a dew point of −50° C. Further, inert gas may include argon (Ar) gas.

The first layer 30′ may be formed to have the same area as that of the cathode part 10 which will be described later. When the area of the first layer 30′ is greater than the area of the cathode part 10, the transfer state of the first layer 30′ may be poor and, when the area of the first layer 30′ is less than the area of the cathode part 10, a short-circuit between the cathode part 10 and the anode part 20 may be caused.

The first layer 30′ may be formed to have a thickness less than the thickness of the second layer 40′ which will be described later. The thickness of the cathode part 10 is greater than the thickness of the anode part 20. Therefore, there is a high possibility that one layer transferred on the cathode part 10 is bent. This is because the difference in the degree of volume expansion between transferred surface and the opposite surface of the cathode part 10 is larger than that of the anode part 20. This will be described later.

Referring to FIG. 2B, the second solid electrolyte part may include the second transfer film layer 41 and the second layer 40′ disposed on the second transfer film layer 41.

The second transfer film layer 41 may include at least one selected from the group consisting of polyethylene naphthalate (PEN), fluorinated polyimide (FPI) and a combination thereof.

The second layer 40′ may be formed by applying a slurry including at least a second solid electrolyte and a binder to the second transfer film layer 41.

The second solid electrolyte may include a sulfide-based solid electrolyte. The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), or Li₁₀GeP₂S₁₂.

The binder may include a butadiene rubber (BR)-based binder, an acrylate-based binder, a fluorine-based binder or the like.

The slurry may further include a solvent, a dispersant, etc. The solvent may include any solvent which does not react with the sulfide-based solid electrolyte or has low reactivity with the sulfide-based solid electrolyte. For example, the solvent may include heptane, xylene, butyl butyrate, toluene, or the like.

The slurry may be manufactured by adding the sulfide-based solid electrolyte, the binder and the dispersant into the solvent and mixing all the components. For example, the slurry may be manufactured by mixing the sulfide-based solid electrolyte, the binder and the dispersant at a weight ratio of about 94-99:0.9-5:0.1-1.

The second layer 40′ may be formed by applying the slurry to the second transfer film layer 41 and then drying the slurry. Application of the slurry is not limited to a specific method, and may be achieved by methods using tape casting, a doctor blade, etc. After the slurry is applied, the slurry may be dried at a temperature of about 60° C. to 150° C. in a dry room, in a vacuum or in an inert gas atmosphere. Here, the dry room may indicate a space configured such that air therein maintains a dew point of −50° C. Further, inert gas may include argon (Ar) gas.

The second layer 40′ may be formed to have the same area as the anode part 20 which will be described later. When the area of the second layer 40′ is greater than the area of the anode part 20, the transfer state of the second layer 40′ may be poor and, when the area of the second layer 40′ is less than the area of the anode part 20, a short-circuit between the cathode part 10 and the anode part 20 may be caused.

Referring to FIG. 2C, the first solid electrolyte layer 30 may be formed by transferring the first layer 30′ onto the cathode part 10.

The cathode part 10 may include a cathode current collector layer 11, and a cathode active material layer 12 disposed on the cathode current collector layer 11.

The cathode current collector layer 11 may be a plate-shaped substrate having electrical conductivity. The cathode current collector layer 11 may include an aluminum foil.

The cathode active material layer 12 may include a cathode active material, a sulfide-based solid electrolyte, a conductive material, a binder and a dispersant.

The cathode active material may include an oxide-based active material. For example, the oxide-based active material may include LiCoO₂, LiNi_{1/3}Co_{1/3}Mn_{1/3}O₂, LiNi_{0.5}Co_{0.2}Mn_{0.3}O₂, LiNi_{0.6}Co_{0.2}Mn_{0.2}O₂, LiNi_{0.8}Co_{0.1}Mn_{0.1}O₂, LiNi_{0.8}Co_{0.1}Al_{0.1}O₂, LiFePO₄, or Li₄Ti₅O₁₂. The cathode active material may be coated with LiNbO₃, Li₃PO₄ or Li₄Ti₅O₁₂.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), or Li₁₀GeP₂S₁₂.

The conductive material may include carbon black, carbon nanotubes, carbon nanofiber, vapor-grown carbon fiber or the like.

The binder may include a butadiene rubber (BR)-based binder, a fluorine-based binder or the like.

The cathode active material layer 12 may be formed by applying a slurry obtained by adding the cathode active material, the sulfide-based solid electrolyte, the conductive material, the binder and the dispersant into a solvent and mixing all the components, to the cathode current collector layer 11 and then drying the slurry.

The solvent may include any solvent which does not react with the sulfide-based solid electrolyte or has low reactivity with the sulfide-based solid electrolyte. For example, the solvent may include heptane, xylene, butyl butyrate, toluene, or the like.

The slurry may be manufactured by mixing the cathode active material, the sulfide-based solid electrolyte, the conductive material, the binder and the dispersant at a weight ratio of about 65.0-86.4:10.0-25.0:2.0-5.0:1.5-4.0:0.1-1.0.

Application of the slurry is not limited to a specific method, and may be achieved by methods using tape casting, a doctor blade, etc. After the slurry is applied, the slurry may be dried at a temperature of about 60° C. to 150° C. in a dry room, in a vacuum or in an inert gas atmosphere. Here, the dry room may indicate a space configured such that air therein maintains a dew point of −50° C. Further, inert gas may include argon (Ar) gas.

The first layer 30′ may be transferred onto the cathode part 10 by stacking the first solid electrolyte part on the cathode part 10, concretely, the cathode active material layer 11 such that the first layer 30′ comes into contact with the cathode active material layer 11, and then applying a pressure of about 130 MPa to 140 MPa at a temperature of about 120° C. to 130° C. After transfer, the first transfer film layer 31 is removed.

The transfer conditions of the first layer 30′ are characterized in that a temperature higher than the temperature of the transfer conditions of the second layer 40′ and a pressure lower than the pressure of the transfer conditions of the second layer 40′ are applied. When transferred onto the cathode part 10, there is a high possibility that the transferred product is bent. The above conditions are to prevent this. Therefore, the first solid electrolyte layer 30 and the second solid electrolyte layer 40 have different densities. This will be described later.

Transfer of the first layer 30′ is not limited to a specific method, and the first layer 30′ may be transferred onto the cathode part 10 by any method, as long as heat and pressure may be uniformly applied. For example, transfer may be performed by a method using a roll press, a flat press or the like.

The thickness of the first solid electrolyte layer 30 may be about 15 μm to 25 μm. When the thickness of the first solid electrolyte layer 30 exceeds 25 μm, there is a possibility that the transfer product warps.

The first solid electrolyte layer 30 may be formed by transferring the first layer 30′ onto the cathode part 10 so as to satisfy Equation 1 below. Bending of the transfer product may be effectively prevented by satisfying Equation 1.

$$15 \leq \frac{{V}_{1 , 0} - {V}_{1}}{{V}_{1 , 0}} \times 100 \leq 20 \qquad [ Equation 1 ]$$

In Equation 1, V_{1,0} may the volume of the first layer 30′, and V₁ may be the volume of the first solid electrolyte layer 30.

Referring to FIG. 2D, the second solid electrolyte layer 40 may be formed by transferring the second layer 40′ onto the anode part 20.

The anode part 20 may include an anode current collector layer 21, and an anode layer 22 located on the anode current collector layer 21.

The anode current collector layer 21 may be a plate-shaped base material having electrical conductivity. The anode current collector layer 21 may include at least one selected from the group consisting of nickel (Ni), stainless steel (SUS) and a combination thereof.

A first embodiment of the anode layer 22 may include an anode active material layer including an anode active material, a sulfide-based solid electrolyte, a binder, etc.

The anode active material may be, for example, a carbon active material or a metal active material, without being limited to a specific material, The carbon active material may be graphite, such as mesocarbon microbeads (MCMB) or highly oriented pyrolytic graphite (HOPG), or amorphous carbon, such as hard carbon or soft carbon. The metal active material may be In, Al, Si, Sn, or an alloy including at least one thereof.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), or Li₁₀GeP₂S₁₂.

The binder may include a butadiene rubber (BR)-based binder, a fluorine-based binder or the like.

The anode active material layer may be formed by applying a slurry, acquired by putting the anode active material, the sulfide-based solid electrolyte and the binder into a solvent and mixing all the components, to the anode current collector layer 21 and then drying the slurry.

The solvent may include any solvent which does not react with the sulfide-based solid electrolyte or has low reactivity with the sulfide-based solid electrolyte. For example, the solvent may include heptane, xylene, butyl butyrate, toluene, or the like.

Application of the slurry is not limited to a specific method, and may be achieved by methods using tape casting, a doctor blade, etc. After the slurry is applied, the slurry may be dried at a temperature of about 60° C. to 150° C. in a dry room, in a vacuum or in an inert gas atmosphere. Here, the dry room may indicate a space configured such that air therein maintains a dew point of −50° C. Further, inert gas may include argon (Ar) gas.

A second embodiment of the anode layer 22 may include a lithium metal layer. The lithium metal layer may include lithium metal or a lithium metal alloy. The lithium metal alloy may include an alloy of lithium and a metal or a metalloid which is alloyable with lithium. The metal or the metalloid which is alloyable with lithium may include Si, Sn, Al, Ge, Pb, Bi, Sb or the like.

The anode part 20 may be formed by adhering the lithium metal layer to the anode current collector layer 21.

A third embodiment of the anode layer 22 may not include any anode active material and any element which performs substantially the same function as the anode active material. Lithium ions migrating from the cathode part 10 precipitate in the form of lithium metal between the anode layer 22 and the anode current collector layer 21, and are stored, when the all-solid-state battery is charged. The anode layer 22 may include a coating layer including a carbon material and a metal which may form an alloy with lithium.

The carbon material may include at least one selected from the group consisting of furnace black, acetylene black, ketjen black, graphene and combinations thereof.

The metal may include at least one selected from the group consisting of gold (Au), platinum (Pt), palladium (Pd), silicon (Si), silver (Ag), aluminum (Al), bismuth (Bi), tin (Sn), zinc (Zn) and combinations thereof.

The second layer 40′ may be transferred onto the anode part 20 by stacking the second solid electrolyte part on the anode part 20, concretely, the anode layer 21 such that the second layer 40′ comes into contact with the anode layer 21, and then applying a pressure of about 140 MPa to 150 MPa at a temperature of about 100° C. to 110° C. After transfer, the second transfer film layer 41 is removed.

Transfer of the second layer 40′ is not limited to a specific method, and the second layer 40′ may be transferred onto the anode part 20 by any method, as long as heat and pressure may be uniformly applied. For example, transfer may be performed by a method using a roll press, a flat press or the like.

The thickness of the second solid electrolyte layer 40 may be about 30 μm to 40 μm. The second solid electrolyte layer 40 transferred onto the anode part 20 has a lower possibility that a transfer product warps than the first solid electrolyte layer 30, and may thus have a greater thickness than that of the first solid electrolyte layer 30.

The second solid electrolyte layer 40 may be formed by transferring the second layer 40′ onto the anode part 20 so as to satisfy Equation 2 below. Warpage of the transfer product may be effectively prevented by satisfying Equation 2.

$$20 \leq \frac{{V}_{2 , 0} - {V}_{2}}{{V}_{2 , 0}} \times 100 \leq 25 \qquad [ Equation 2 ]$$

In Equation 2, V_{2,0} may the volume of the second layer 40′, and V₂ may be the volume of the second solid electrolyte layer 40.

Referring to FIG. 2E, the stack is prepared by stacking the first solid electrolyte layer 30 and the second solid electrolyte layer 40 so as to come into contact with each other.

Thereafter, in FIG. 2F, the insulating member 50 may be adhered to the side surfaces of the stack. The insulating member 50 is not limited to a specific material, and may use any insulating material which has excellent mechanical properties. For example, the insulating member 50 may include polyethylene terephthalate or the like. The insulating member 50 may be adhered to the side surfaces of the stack, or may be adhered to the side surfaces of an assembly structure including the anode part 20 and the second solid electrolyte layer 40 before the stack is obtained. The introduction timing of the insulating member 50 may be properly changed depending on the structures of the respective layers, a manufacturing apparatus, etc.

Referring to FIG. 2G, the method according to the present disclosure may further include pressing the stack. Concretely, the stack may be isostatically pressed at a pressure of about 400 MPa to 500 MPa and a temperature of about 60° C. to 100° C. Here, isostatic pressing may indicate a process of applying equal pressure using gas, such as Ar, as a pressure medium.

The all-solid-state battery acquired by the above-described method is characterized in that the second solid electrolyte layer 40 has a thickness greater than that of the first solid electrolyte layer 30. When the anode part 20 includes the above-described lithium metal layer or coating layer, the cathode part 10 has a thickness greater than that of the anode part 20. Therefore, when the first solid electrolyte layer 30 is transferred onto the cathode part 10, there is a large temperature difference between a transfer surface and a non-transfer surface of the cathode part 10 in the thickness direction thereof, and such a temperature difference causes a large volume expansion degree difference therebetween. When the first solid electrolyte layer 30 is pressed, the sulfide-based solid electrolyte included in the first solid electrolyte layer 30 becomes rigid and thus the first solid electrolyte layer 30 is not easily bent, and such tendency becomes severed as the thickness of the first electrolyte layer 30 increases. That is, when the first solid electrolyte layer 30 is formed to a large thickness on the cathode part 10, the first solid electrolyte layer 30 may be easily broken due to a volume expansion degree difference of the cathode part 10 in the thickness direction thereof. On the other hand, the anode part 20 has a thickness less than that of the cathode part 10, and thus has a relatively small volume expansion degree difference in the thickness direction thereof, and thereby, although the second solid electrolyte layer 40 is formed to a relatively large thickness, the second solid electrolyte layer 40 is neither broken nor cracked.

Concretely, the ratio (a/b) of the thickness (a) of the first solid electrolyte layer to the thickness (b) of the second solid electrolyte layer 40 may be about 0.37 to 0.83. When the thickness ratio of the first solid electrolyte layer 30 to the second solid electrolyte layer 40 satisfies the above numerical range, the first solid electrolyte layer 30 and the second solid electrolyte layer 40 may be bonded to each other without warpage.

Warpage of the first solid electrolyte layer 30 and the second solid electrolyte layer 40 may be incurred also by a pressure applied during transfer. When each layer is transferred, the warpage degree thereof is increased as the applied pressure increases. The first solid electrolyte layer 30 is bent more easily than the second solid electrolyte layer 40, as described above, and may thus be formed at a lower temperature and a lower pressure, and thereby, the density of the first solid electrolyte layer 30 is lower than the density of the second solid electrolyte layer 40. Concretely, the density of the first solid electrolyte layer 30 may be about 1.20 mg/mm³ to 1.40 mg/mm³, and the density of the second solid electrolyte layer 40 may be about 1.40 mg/mm³ to 1.60 mg/mm³.

The second solid electrolyte layer 40 may be divided into the central part and the edge part other than the central part based on the plane of the second solid electrolyte layer 40, and the first solid electrolyte layer 30 may be adhered to the second solid electrolyte layer 40 so as to be located on the central part thereof.

In the all-solid-state battery having the above structure, a stepped part is formed on the side surfaces of the anode part 20, the second solid electrolyte layer 40, the first solid electrolyte layer 30 and the cathode part 10, as shown in FIG. 1. Therefore, the insulating member 50 may have side surfaces having a shape corresponding to the contour of the side surfaces of the all-solid-state battery.

The all-solid-state battery according to the present disclosure may include not only a unit cell shown in FIGS. 1 and 2G but also a stack acquired by stacking a plurality of unit cells.

Hereinafter, the present disclosure will be described in more detail through the following examples. The following examples serve merely to exemplarily describe the present disclosure, and are not intended to limit the scope of the disclosure.

### EXAMPLE

A first solid electrolyte part was prepared by forming a first layer including a sulfide-based solid electrolyte on a first transfer film layer including polyethylene naphthalate.

A second solid electrolyte part was prepared by forming a second layer including a sulfide-based solid electrolyte on a second transfer film layer including polyethylene naphthalate.

The first layer was transferred onto a cathode part by stacking the first solid electrolyte part on the cathode part such that the first layer comes into contact with the cathode part, and then applying a pressure of 135 MPa at a temperature of 120° C. The thickness of the transferred first solid electrolyte layer was about 25 μm. Transfer was carried out using flat press equipment. After transfer, the first transfer film layer was removed.

The second layer was transferred onto an anode part by stacking the second solid electrolyte part on the anode part such that the second layer comes into contact with the anode part, and then applying a pressure of 145 MPa at a temperature of 110° C. The thickness of the transferred second solid electrolyte layer was about 30 μm. Transfer was carried out using flat press equipment. After transfer, the second transfer film layer was removed. An insulating tape was adhered to the side surfaces of a resultant product.

A stack was prepared by stacking the first solid electrolyte layer and the second solid electrolyte layer so as to come into contact with each other, and was vacuum-sealed in a pouch. An all-solid-state battery was manufactured by isostatically pressing the pouch by applying a pressure of 450 MPa at a temperature of 80° C.

In order to detect a densification degree of the first and second solid electrolyte layers included in the all-solid-state battery, shear strength, peel strength and stiffness of the first and second solid electrolyte layers were measured. These properties were measured using analysis equipment, i.e., a Surface And Interfacial Characterizing Analysis System (SAICAS) and a stiffness tester. Results are set forth in Table 1 below.

TABLE 1

| Transfer | Transfer | Stiffness | Shear strength | Peel strength |
|---|---|---|---|---|
| pressure [MPa] | Temp. [° C.] | [g/cm] | [MPa] | [N/m] |
| 145 | 110 | 0.21 | 2.07 | 8.0 |

FIG. 3A shows an initial discharge capacity of the all-solid-state battery according to Example. FIG. 3B shows lifespan characteristics of the all-solid-state battery according to Example. Referring to these figures, the all-solid-state battery manufactured according to the present disclosure exhibited an initial discharge capacity of 176.9 mAh/g and initial efficiency of 86.2%, and maintained a capacity of 90.1% during 40 cycles.

### COMPARATIVE EXAMPLE 1

A solid electrolyte part was prepared by forming a solid electrolyte layer having a thickness of 55 μm and including a sulfide-based solid electrolyte on a transfer film layer including polyethylene naphthalate.

The solid electrolyte layer was transferred onto the same anode part as that used in Example by stacking the solid electrolyte part on the anode part such that the solid electrolyte comes into contact with the anode part, and then applying a pressure of 143 MPa at a temperature of 110° C. Transfer was carried out using flat press equipment. After transfer, the transfer film layer was removed. An insulating tape was adhered to the side surfaces of a resultant product.

A stack was prepared by stacking a cathode part on the solid electrolyte layer, and was vacuum-sealed in a pouch. An all-solid-state battery was manufactured by isostatically pressing the pouch by applying a pressure of 450 MPa at a temperature of 80° C.

Shear strength, peel strength and stiffness of the solid electrolyte layer included in the all-solid-state battery were measured. Results are set forth in Table 2 below.

TABLE 2

| Transfer | Transfer | Stiffness | Shear strength | Peel strength |
|---|---|---|---|---|
| pressure [MPa] | Temp. [° C.] | [g/cm] | [MPa] | [N/m] |
| 143 | 110 | 0.26 | 2.15 | 9.0 |

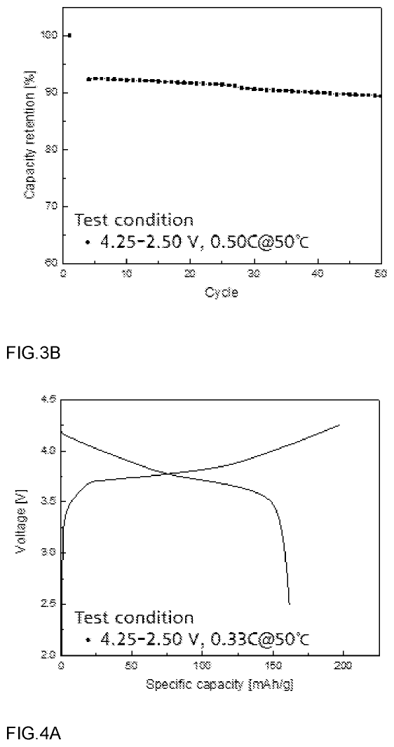

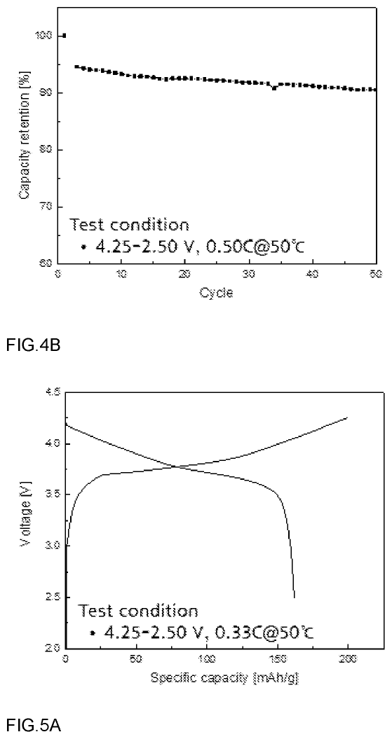

FIG. 4A shows an initial discharge capacity of the all-solid-state battery according to Comparative Example 1. FIG. 4B shows lifespan characteristics of the all-solid-state battery according to Comparative Example 1. Referring to these figures, the all-solid-state battery according to Comparative Example 1 exhibited an initial discharge capacity of 161.4 mAh/g and initial efficiency of 82.0%, and maintained a capacity of 91.2% during 40 cycles.

### COMPARATIVE EXAMPLE 2

An all-solid-state battery was manufactured in the same manner as in Comparative Example 1, except that the transfer pressure was lowered to 134 MPa.

Shear strength, peel strength and stiffness of a solid electrolyte layer included in the all-solid-state battery were measured. Results are set forth in Table 3 below.

TABLE 3

| Transfer | Transfer | Stiffness | Shear strength | Peel strength |
|---|---|---|---|---|
| pressure [MPa] | Temp. [° C.] | [g/cm] | [MPa] | [N/m] |
| 134 | 110 | 0.16 | 1.81 | 3.0 |

FIG. 5A shows an initial discharge capacity of the all-solid-state battery according to Comparative Example 2. FIG. 5B shows lifespan characteristics of the all-solid-state battery according to Comparative Example 2. Referring to these figures, the all-solid-state battery according to Comparative Example 2 exhibited an initial discharge capacity of 161.6 mAh/g and initial efficiency of 81.3%, and maintained a capacity of 65.6% during 40 cycles.

### COMPARATIVE EXAMPLE 3

An all-solid-state battery was manufactured in the same manner as in Comparative Example 1, except that the transfer pressure was raised to 152 MPa.

Shear strength, peel strength and stiffness of a solid electrolyte layer included in the all-solid-state battery were measured. Results are set forth in Table 4 below.

TABLE 4

| Transfer | Transfer | Stiffness | Shear strength | Peel strength |
|---|---|---|---|---|
| pressure [MPa] | Temp. [° C.] | [g/cm] | [MPa] | [N/m] |
| 152 | 110 | 0.32 | 3.38 | 11.0 |

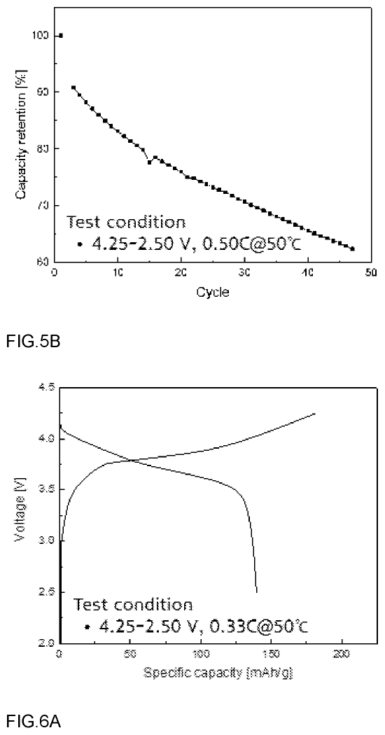

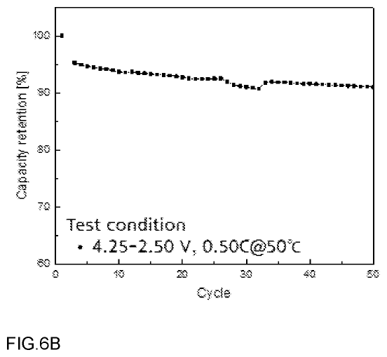

FIG. 6A shows an initial discharge capacity of the all-solid-state battery according to Comparative Example 3. FIG. 6B shows lifespan characteristics of the all-solid-state battery according to Comparative Example 3. Referring to these figures, the all-solid-state battery according to Comparative Example 3 exhibited an initial discharge capacity of 139.6 mAh/g and initial efficiency of 77.0%, and maintained a capacity of 91.6% during 40 cycles.

Referring to the above results, it may be confirmed that the all-solid-state battery according to Example exhibited the highest initial discharge capacity and initial efficiency and had excellent capacity retention.

As is apparent from the above description, the present disclosure may provide an all-solid-state battery which may minimize interfacial resistance of a transferred solid electrolyte layer, and a method for manufacturing the same.

The all-solid-state battery according to the present disclosure may have a high capacity and excellent durability.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A method for manufacturing an all-solid-state battery, comprising:
preparing a first solid electrolyte part comprising a first transfer film layer, and a first layer disposed on the first transfer film layer and comprising a first solid electrolyte;
preparing a second solid electrolyte part comprising a second transfer film layer, and a second layer disposed on the second transfer film layer and comprising a second solid electrolyte;
forming a first solid electrolyte layer on a cathode part by transferring the first layer onto the cathode part;
forming a second solid electrolyte layer on an anode part by transferring the second layer onto the anode part; and
preparing a stack by stacking the first solid electrolyte layer and the second solid electrolyte layer so as to come into contact with each other.

2. The method of claim 1, wherein the first transfer film layer comprises at least one of polyethylene naphthalate (PEN), fluorinated polyimide (FPI), or any combination thereof.

3. The method of claim 1, wherein the first layer is formed by applying a slurry to the first transfer film layer, and
the slurry comprises at least a sulfide-based solid electrolyte and a binder.

4. The method of claim 1, wherein the second transfer film layer comprises at least one of polyethylene naphthalate (PEN), fluorinated polyimide (FPI), or any combination thereof.

5. The method of claim 1, wherein the second layer is formed by applying a slurry to the second transfer film layer, and
the slurry comprises at least a sulfide-based solid electrolyte and a binder.

6. The method of claim 1, wherein the first layer is transferred onto the cathode part by stacking the first solid electrolyte part on the cathode part such that the first layer comes into contact with the cathode part and then applying a pressure of about 130 MPa to 140 MPa at a temperature of about 120° C. to 130° C.

7. The method of claim 1, wherein a thickness of the first solid electrolyte layer ranges from about 15 μm to 25 μm.

8. The method of claim 1, wherein the first layer and the first solid electrolyte layer satisfy Equation 1 below,
$$15 \leq \frac{{V}_{1 , 0} - {V}_{1}}{{V}_{1 , 0}} \times 100 \leq 20 , \qquad [ Equation 1 ]$$
wherein V_{1,0} indicates a volume of the first layer, and V₁ indicates a volume of the first solid electrolyte layer.

9. The method of claim 1, wherein a thickness of the second solid electrolyte layer ranges from about 30 μm to 40 μm.

10. The method of claim 1, wherein the second layer is transferred onto the anode part by stacking the second solid electrolyte part on the anode part such that the second layer comes into contact with the anode part and then applying a pressure of about 140 MPa to 150 MPa at a temperature of about 100° C. to 110° C.

11. The method of claim 1, wherein the second layer and the second solid electrolyte layer satisfy Equation 2 below,
$$20 \leq \frac{{V}_{2 , 0} - {V}_{2}}{{V}_{2 , 0}} \times 100 \leq 25 , \qquad [ Equation 2 ]$$
wherein V_{2,0} indicates a volume of the second layer, and V₂ indicates a volume of the second solid electrolyte layer.

12. The method of claim 1, further comprising isostatically pressing the stack at a pressure of about 400 MPa to 500 MPa and a temperature of about 60° C. to 100° C.

13. An all-solid-state battery comprising:
an anode part;
a second solid electrolyte layer disposed on the anode part;
a first solid electrolyte layer disposed on the second solid electrolyte layer; and
a cathode part disposed on the first solid electrolyte layer,
wherein the first solid electrolyte layer and the second electrolyte layer have different thicknesses.

14. The all-solid-state battery of claim 13, wherein a thickness of the second solid electrolyte layer is greater than a thickness of the first solid electrolyte layer.

15. The all-solid-state battery of claim 13, wherein a thickness of the first solid electrolyte layer ranges from about 15 μm to 25 μm.

16. The all-solid-state battery of claim 13, wherein a thickness of the second solid electrolyte layer ranges from about 30 μm to 40 μm.

17. The all-solid-state battery of claim 13, wherein a ratio (a/b) of a thickness (a) of the first solid electrolyte layer to a thickness (b) of the second solid electrolyte layer ranges from about 0.37 to 0.83.

18. The all-solid-state battery of claim 13, wherein a density of the first solid electrolyte layer ranges from about 1.20 mg/mm³ to 1.40 mg/mm³.

19. The all-solid-state battery of claim 13, wherein a density of the second solid electrolyte layer ranges from about 1.40 mg/mm³ to 1.60 mg/mm³.

20. The all-solid-state battery of claim 13, wherein:
the second solid electrolyte layer comprises a central part and an edge part other than the central part with respect to a plane of the second solid electrolyte layer; and
the first solid electrolyte layer is disposed on the central part.
